(19) United States
(12) Patent Application Publication
(10) Pub. No.: US 2021/0280896 A1
(43) Pub. Date: Sep. 9, 2021

(54) FLEXIBLE BATTERY CONFIGURATIONS

(71) Applicant: Apple Inc., Cupertino, CA (US)

(72) Inventors: Yuriy Y. Londarenko, Scotts Valley, CA (US); Shabab Amiruddin, Menlo Park, CA (US)

(73) Assignee: Apple Inc., Cupertino, CA (US)

(21) Appl. No.: 16/812,606

(22) Filed: Mar. 9, 2020

(51) Int. Cl. H01M 10/04; H01M 2/02; H02J 7/00; G06F 1/16

(52) U.S. Cl. CPC H01M 10/0436; H01M 2/0207; H01M 2002/0205; G06F 1/1681; H01M 2220/30; H02J 7/0044

(57) ABSTRACT

Electronic devices according to embodiments of the present technology may include a first device section having an electronic connector. The first device section may be characterized by a first thickness. The electronic devices may include a second device section characterized by a second thickness. The electronic devices may include a hinge section extending along a length of the first device section and a length of the second device section. The second device section may be bendably coupled with the first device section about the hinge section. The hinge section may be characterized by a third thickness less than the first thickness and the second thickness. The electronic devices may include a battery including a first battery section housed in the first device section. The battery may include a second battery section housed in the second device section.

### TECHNICAL FIELD

The present technology relates to battery-powered devices. More specifically, the present technology relates to electronic device configurations providing flexible movement of aspects of the device.

### BACKGROUND

Batteries within an electronic device impact the time during which the device may be operated. As electronic devices reduce in size, the available space for components including batteries may be limited, which may affect the time of operation.

### SUMMARY

Electronic devices according to embodiments of the present technology may include a first device section having an electronic connector. The first device section may be characterized by a first thickness. The electronic devices may include a second device section characterized by a second thickness. The electronic devices may include a hinge section extending along a length of the first device section and a length of the second device section. The second device section may be bendably coupled with the first device section about the hinge section. The hinge section may be characterized by a third thickness less than the first thickness and the second thickness. The electronic devices may include a battery including a first battery section housed in the first device section. The first battery section may include a current collector, a first electrode active material, and a separator. The battery may include a second battery section housed in the second device section. The second battery section may include the current collector, a second electrode active material, and the separator. The current collector and the separator may extend through the hinge section of the electronic device.

In some embodiments, the electronic devices may include a battery control board electrically coupling the battery with the electronic connector. The electronic connector may include a contact connector or a magnetically actuated connector. The first device section and the second device section may be configured to maintain rigidity while the hinge section is articulated. The current collector may define an aperture through the current collector at the hinge section. The battery may include a pouch extending continuously about the first battery section and the second battery section. The pouch may include a polymeric material, and the pouch may be sealingly coupled with the separator through the aperture defined through the current collector. The battery may include an electrolyte, and both the first battery section and the second battery section may be fluidly accessible to the electrolyte.

Some embodiments of the present technology may encompass electronic devices including a first device section having an electronic connector. The first device section may be characterized by a first thickness. The electronic devices may include a second device section characterized by a second thickness. The electronic devices may include a hinge section extending between the first device section and the second device section. The second device section may be bendably coupled with the first device section about the hinge section. The hinge section may be characterized by a third thickness less than the first thickness and the second thickness. The electronic devices may include a battery system having a first battery cell housed within the first device section and extending substantially parallel to the hinge section of the electronic device. The battery system may include a second battery cell housed within the second device section and extending substantially parallel to the hinge section of the electronic device. The battery system may include a battery control board electrically coupling the first battery cell and the second battery cell with the electronic connector.

In some embodiments, the battery control board may include a first control board section housed in the first device section. The first control board section may be electrically coupled with the first battery cell. The battery control board may include a second control board section housed in the second device section. The second control board section may be electrically coupled with the second battery cell. The battery control board may include a flex section coupling the first control board section with the second control board section, and the flex section may extend through the hinge section of the electronic device. The flex section may include a conductive film extending from the first control board section to the second control board section, and the conductive film may be encapsulated in a polymeric material between the first control board section and the second control board section. The electronic devices may include a housing extending about the first device section, the second device section, and the hinge section of the electronic device. The housing may include a polymeric material, and the housing may be sealingly coupled with the polymeric material encapsulating the conductive film. The electronic connector may be or include a contact connector or a magnetically actuated connector.

Some embodiments of the present technology may encompass electronic systems including a first electronic device having a display on a first surface of the first electronic device. The first electronic device may include a first electronic connector, and the first electronic device may include a first battery housed within the first electronic device. The electronic systems may include a second electronic device including a first device section having a second electronic connector. The first device section may be characterized by a first thickness. The second electronic device may include a second device section characterized by a second thickness. The second electronic device may include a hinge section extending along a length of the first device section and a length of the second device section. The second device section may be bendably coupled with the first device section about the hinge section. The second electronic device may include a second battery having a first battery section housed in the first device section. The first battery section may include a current collector, a first section of an electrode active material, and a separator. The second battery may include a second battery section housed in the second device section. The second battery section may include the current collector, a second section of the electrode active material, and the separator. The current collector and the separator may extend through the hinge section of the second electronic device.

In some embodiments, the second electronic connector may be configured to engage with the first electronic connector. The second electronic connector may be further configured to provide power to the first electronic device from the second battery. The current collector may define an aperture through the current collector at the hinge section. The second battery may include a pouch extending continuously about the first battery section and the second battery section. The pouch may include a polymeric material, and the pouch may be sealingly coupled with the separator through the aperture defined through the current collector.

Such technology may provide numerous benefits over conventional technology. For example, the present systems may provide additional battery capacity that can be used with connected electronic devices. Additionally, configurations of electronic devices according to embodiments of the present technology may afford mechanical flexibility to the devices. These and other embodiments, along with many of their advantages and features, are described in more detail in conjunction with the below description and attached figures.

### BRIEF DESCRIPTION OF THE DRAWINGS

A further understanding of the nature and advantages of the disclosed embodiments may be realized by reference to the remaining portions of the specification and the drawings.

FIG. 1 shows a schematic isometric view of an electronic device according to some embodiments of the present technology.

FIG. 2 shows a schematic cross-sectional view of a battery cell according to some embodiments of the present technology.

FIG. 3 shows a schematic view of components of an electronic device according to some embodiments of the present technology.

FIG. 4A shows a schematic cross-sectional view of a battery cell according to some embodiments of the present technology.

FIG. 4B shows a schematic top view of a battery cell according to some embodiments of the present technology.

FIG. 4C shows a schematic cross-sectional view of a battery according to some embodiments of the present technology.

FIG. 5 shows a schematic view of components of an electronic device according to some embodiments of the present technology.

FIG. 6 shows a schematic cross-sectional view of a battery control board according to some embodiments of the present technology.

FIG. 7 shows a schematic view of an electronic system according to some embodiments of the present technology.

Several of the figures are included as schematics. It is to be understood that the figures are for illustrative purposes, and are not to be considered of scale unless specifically stated to be of scale. Additionally, as schematics, the figures are provided to aid comprehension and may not include all aspects or information compared to realistic representations, and may include exaggerated material for illustrative purposes.

In the figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION

Batteries, battery cells, and more generally energy storage devices, are used in a host of different systems. In many devices, the battery cells may be designed with a balance of characteristics in mind. For example, including larger batteries may provide increased usage between charges, however, the larger batteries may require larger housing, or increased space within the device. As device designs and configurations change, especially in efforts to reduce device sizes, the available space for additional battery system components may be constrained. These constraints may include restrictions in available volume as well as the geometry of such a volume. Conventional devices have often been restricted to larger form factors to accommodate both a sufficient battery as well as associated battery system components. The present technology may overcome these issues, however, by providing electronic devices that may be electronically coupled with other electronic devices to provide additional battery power. This may allow some electronic devices to be reduced in size by reducing the internal battery of the device and utilizing additional battery storage in the coupled electronic device. By utilizing configurations according to some embodiments of the present technology, flexible devices may be coupled with other electronic devices. After illustrating an exemplary electronic device that may be coupled with electronic devices having flexible battery configurations, as well as a cell that may be used in some embodiments of the present technology, the present disclosure will describe battery system designs having a controlled form factor for use in a variety of devices in which battery cells may be used

Although the remaining portions of the description will routinely reference tablet devices, it will be readily understood by the skilled artisan that the technology is not so limited. The present materials and technology may be employed with any number of electronic devices that may include, without limitation, phones and mobile devices, watches, glasses, and other wearable technology including fitness devices, handheld electronic devices, laptops, tablets, and other computers, as well as other devices that may benefit from the use of wireless charging technology.

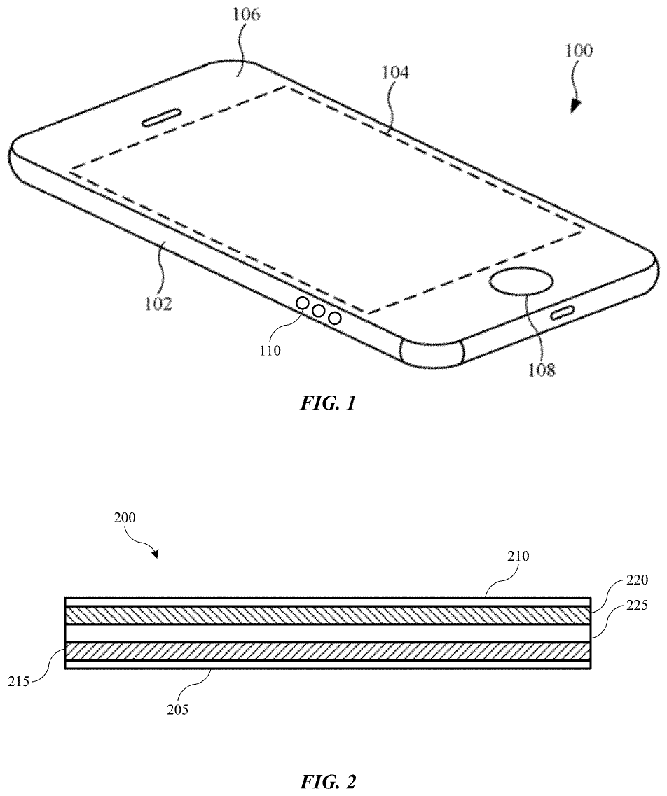

FIG. 1 shows a schematic isometric view of an electronic device 100 according to some embodiments of the present technology. Electronic device 100 may illustrate a number of devices, which may include a personal computing device or mobile device, for example. Additionally, electronic device 100 may be a tablet computing device, wearable electronic device, as well as a mobile communication device, such as a smartphone. Electronic device 100 may include an enclosure 102, or housing, that defines an internal cavity or interior volume to receive several internal components, some of which will be described below, and which may include components such as a circuit board, processor circuit, memory circuit, charging coils, and an internal power supply or battery, as non-limiting examples. The enclosure 102 may include a metal, such as aluminum or steel, or a metal alloy that includes two or more metals. Alternatively, the enclosure 102 may include a non-metal material or materials, such as ceramics, polymers, glass, or other flexible materials including combinations of metal and non-metal materials.

The electronic device 100 may further include an active region 104 shown as a dotted line, although in some embodiments region 104 may be a coextensive portion of the enclosure 102. When present, active region 104 may include a transfer surface, or a display surface designed to present visual information in the form of still images and/or video. The active region 104 may include a capacitive touch sensitive layer designed to receive a touch input to alter the visual information. Also, the electronic device 100 may include a protective cover 106 that overlays the active region 104, when present. The protective cover 106 may include a transparent material, such as glass or sapphire, as non-limiting examples, and may include EMF shielding materials, or other materials through which electronic transfer may occur. The electronic device 100 may or may not further include a button 108 used as a control input to a processor circuit, although in either embodiment the active region 104 may operate as a touch screen to receive user inputs. When included, the button 108 may depress in response to a force, and may provide a control that alters the visual information presented by the active region 104. Additionally, although not shown, the electronic device 100 may include one or more buttons disposed along the enclosure 102 to provide one or more additional control inputs.

Device enclosure 102 may also be configured to protect various electrical components disposed within or along the enclosure. Device enclosure 102 can also define openings within which contacts making up connector 110 can be positioned. The electrical contacts of connector 110 can be configured to provide accessibility through which electronic device 100 can communicate with and exchange, both delivering and receiving, power with or from various accessory devices. A wide variety of accessory devices can benefit from such a connector including but not limited to a powered cover or case, an external battery pack enclosure, an external keyboard, a stylus, a wireless headset or earbuds, a docking station, among many other components. In embodiments, electronic connector 110 may be a contact connector of any configuration, including as a magnetically actuated contact connector as shown. Additionally, electronic connector 110 may be a conventional electronic connector, such as a female socket for receiving a plug or other input connector. Although illustrated along a side surface of electronic device 100, it is to be understood that embodiments of the present technology may include an electronic connector on any surface of the electronic device, including on a rear or back surface opposite a surface on which active region 104 may reside. Electronic connector 110 may allow both data and electrical power to be transferred to and/or from electronic device 100.

FIG. 2 depicts a schematic cross-sectional view of an energy storage device or battery cell 200 according to some embodiments of the present technology. Battery cell 200 may be included in electronic device 100 as described above, and may be included in additional electronic devices as described further below. Battery cell 200 may be or include a battery cell, and may be one of a number of cells coupled together to form a battery structure. As would be readily understood, the layers are not shown at any particular scale, and are intended merely to show the possible layers of cell material of one or more cells that may be incorporated into an energy storage device. In some embodiments, as shown in FIG. 2, battery cell 200 includes a first current collector 205 and a second current collector 210. In embodiments one or both of the current collectors may include a metal or a non-metal material, such as a polymer or composite that may include a conductive material. The first current collector 205 and second current collector 210 may be different materials in embodiments. For example, in some embodiments the first current collector 205 may be a material selected based on the potential of an anode active material 215, and may be or include copper, stainless steel, or any other suitable metal, as well as a non-metal material including a polymer. The second current collector 210 may be a material selected based on the potential of a cathode active material 220, and may be or include aluminum, stainless steel, or other suitable metals, as well as a non-metal material including a polymer. In other words, the materials for the first and second current collectors can be selected based on electrochemical compatibility with the anode and cathode active materials used, and may be any material known to be compatible.

In some instances the metals or non-metals used in the first and second current collectors may be the same or different. The materials selected for the anode and cathode active materials may be any suitable battery materials operable in rechargeable as well as primary battery designs. For example, the anode active material 215 may be silicon, graphite, carbon, a tin alloy, lithium metal, a lithium-containing material, such as lithium titanium oxide (LTO), or other suitable materials that can form an anode in a battery cell. Additionally, for example, the cathode active material 220 may be a lithium-containing material. In some embodiments, the lithium-containing material may be a lithium metal oxide, such as lithium cobalt oxide, lithium manganese oxide, lithium nickel manganese cobalt oxide, lithium nickel cobalt aluminum oxide, or lithium titanate, while in other embodiments the lithium-containing material can be a lithium iron phosphate, or other suitable materials that can form a cathode in a battery cell.

The first and second current collectors as well as the active materials may have any suitable thickness. A separator 225 may be disposed between the electrodes, and may be a polymer film or a material that may allow lithium ions to pass through the structure while not otherwise conducting electricity. Active materials 215 and 220 may additionally include an amount of electrolyte in a completed cell configuration, which may be absorbed within the separator 225 as well. The electrolyte may be a liquid including one or more salt compounds that have been dissolved in one or more solvents. The salt compounds may include lithium-containing salt compounds in embodiments, and may include one or more lithium salts including, for example, lithium compounds incorporating one or more halogen elements such as fluorine or chlorine, as well as other non-metal elements such as phosphorus, and semimetal elements including boron, for example.

In some embodiments, the salts may include any lithium-containing material that may be soluble in organic solvents. The solvents included with the lithium-containing salt may be organic solvents, and may include one or more carbonates. For example, the solvents may include one or more carbonates including propylene carbonate, ethylene carbonate, ethyl methyl carbonate, dimethyl carbonate, diethyl carbonate, and fluoroethylene carbonate. Combinations of solvents may be included, and may include for example, propylene carbonate and ethyl methyl carbonate as an exemplary combination. Any other solvent may be included that may enable dissolving the lithium-containing salt or salts as well as other electrolyte component, for example, or may provide useful ionic conductivities.

Although illustrated as single layers of electrode material, battery cell 200 may be any number of layers. Although the cell may be composed of one layer each of anode and cathode material as sheets, the layers may also be formed into any form such that any number of layers may be included in battery cell 200. For embodiments which include multiple layers, tab portions of each anode current collector may be coupled together, as may be tab portions of each cathode current collector, although one or more of the current collectors may be a continuous current collector material as will be described below. Once the cell has been formed, a pouch, housing, or enclosure may be formed about the cell to contain electrolyte and other materials within the cell structure. Terminals may extend from the enclosure to allow electrical coupling of the cell for use in devices, including an anode and cathode terminal. The coupling may be directly connected with a load that may utilize the power, and in some embodiments the battery cell may be coupled with a control module that may monitor and control charging and discharging of the battery cell. When multiple cells are stacked together, electrode terminals at anode potential may be coupled together, as may be electrode terminals at cathode potential. These coupled terminals may then be connected with the terminals on the enclosure as noted above.

The structure of battery cell 200 may also illustrate the structure of a solid-state battery cell, which may include anode and cathode materials as well as current collectors as noted previously. A difference between the solid-state design and liquid-electrolyte design previously explained is that in addition to not including electrolyte, separator 225 may be characterized by different materials, although the materials may be characterized by similar properties, such as the ability to pass ions through the material while limiting the passage of electrons. In solid-state configurations, the anode and cathode materials may be any of the materials noted above, as well as additional materials operable as electrode active materials within a solid-state cell. For example, anode materials may include graphene or carbon materials, lithium metal, titanium-containing materials, lithium alloys, as well as other anode-compatible materials. Cathode materials may include lithium-containing oxides or phosphates, as well as other cathode-compatible materials.

The inter-electrode material, which may also be noted as 225, may include an electron-blocking material, such as a separator, as well as or alternatively, a solid electrolyte material having ion mobility. Glass materials and ceramics may be used, as well as polymeric materials that may include ion-conducting additives, such as lithium salts. In any instance where the word separator is used, it is to be understood as encompassing both separators and solid electrolytes, which may or may not incorporate separator materials. FIG. 2 is included as an exemplary cell that may be incorporated in batteries according to the present technology. It is to be understood, however, that any number of battery and battery cell designs and materials that may include charging and discharging capabilities similarly may be encompassed by or incorporated with the present technology.

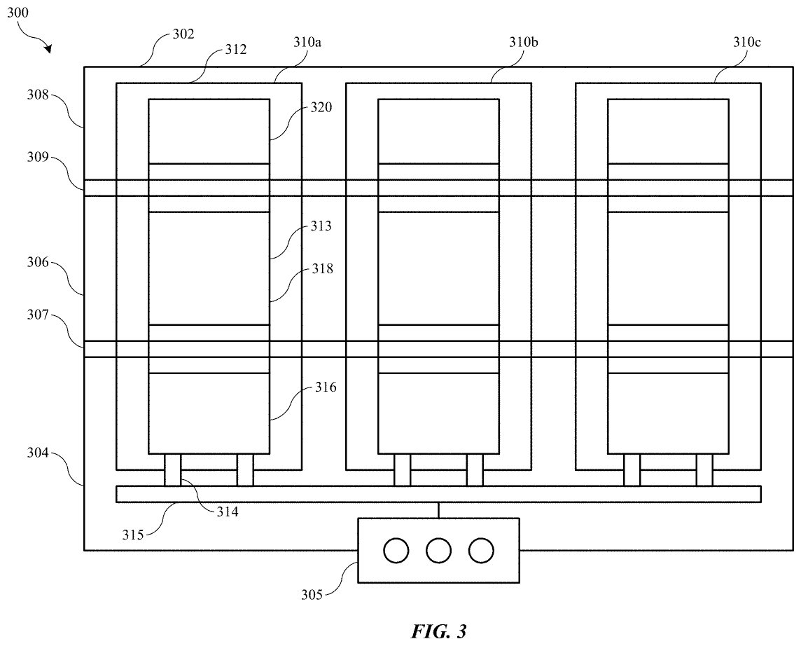

FIG. 3 shows a schematic view of components of an electronic device according to some embodiments of the present technology. It is to be understood that electronic device 300 is included merely to illustrate certain components according to some embodiments of the present technology, and is not intended to accurately represent either scale or position of components that may be incorporated in the device. Electronic device 300 may be or include an electronic device that is coupleable with electronic device 100, where electronic device 100 may include a mobile computing device, for example. For example, electronic device 300 may include an enclosure 302, cover, or structure that may be connected with another electronic device, such as with one or more magnetic or fastening components. Electronic device 300 may illustrate only a partial component, where additional features of the device may also exist. For example, in one non-limiting example, electronic device 300 may be a case, including a case integrating a keyboard or other input device, for electronic device 100, which may be a tablet. Although the remaining disclosure will regularly reference electronic device 300 as a cover, it is to be understood that electronic device 300 may be or include any number of components including a cover, a stand, a case, a housing, an input device that may be or include a keyboard, touchpad, input surface, or any number of other features.

Enclosure 302 may couple with a portion of the electronic device 100, and may electronically and/or communicatively engage with electronic device 100 at connector 110 with a connector 305 of electronic device 300. Again, electronic connector 305 may be any type of connector, such as a socket connector, a contact connector, a magnetically actuated connector, or any other type of connector that may allow data and/or power to be transferred in either direction between the two coupled devices. Although connector 305 may be illustrated extending from a side of the enclosure 302, it is to be understood that the connector may be seated or positioned anywhere on the electronic device 300.

Enclosure 302 may engage with a surface of electronic device 100, such as a backside surface or the front surface, in any number of ways, including with magnetic or physical couplings, as well as an additional section of the electronic device 300 that may engage an alternate surface of the electronic device. Enclosure 302 may provide environmental protection for the electronic device, as well as provide support and staging options for the electronic device. For example, enclosure 302 may include one or more device sections with flexible connections, which may allow the enclosure 302 to be articulated or adjusted to provide a number of support sections for the electronic device. For example, in some embodiments enclosure 302 may include a first device section 304, which may be a section including or incorporating the electronic connector 305. First device section 304 may be connected with one or more additional device sections in some embodiments.

For example, enclosure 302 of electronic device 300 may include a second device section 306. Any number of device sections may be included in exemplary configurations, which may provide a number of options for articulating or adjusting enclosure 302 to support electronic device 100. The configuration illustrated in the figure may also include a third device section 308. The device sections may be characterized by a thickness accommodating one or more internal components, and may be characterized by a rigid structure. Each section may be characterized by a similar or different thickness from any other section in some embodiments, and in some embodiments each device section may be characterized by a similar thickness of the section. The rigid device sections may be coupled together with hinge sections, which may allow articulation of device sections relative to other device sections. A first hinge section 307 may extend along a length of first device section 304 and a length of second device section 306. Similarly, a second hinge section 309 may extend along a length of second device section 306 and a length of third device section 308. The hinge sections may not be rigid as compared to the device sections, and may be flexible to bend in multiple directions. For example, the hinge sections may be characterized by a reduced thickness relative to the thickness of the device sections.

Electronic device 300 may also include one or more battery cells or batteries. As electronic devices such as electronic device 100 continue to reduce in thickness, available space for batteries may be constrained. As power requirements of the devices may increase, the available power or length of time between charges of the device may be reduced. By incorporating additional batteries within electronic device 300, increased energy storage may be afforded. The battery cells may be included within electronic device 300 in one or more configurations to accommodate the hinge sections of the electronic device. As shown in the figure, electronic device 300 may include one or more batteries 310 within enclosure 302. The one or more batteries 310 or battery cells may be electrically coupled with a battery control board 315, which may electrically couple the battery with the electronic connector 305. The figure illustrates a first battery 310a, a second battery 310b, and a third battery 310c, although it is to be understood that embodiments of the present technology may encompass any number of batteries in configurations that may include batteries that are similar or different sizes. In embodiments of the present technology, one or both of the batteries and the battery control board may extend across the hinge sections of the electronic device. While conventional designs may delaminate or fracture during bending or other manipulation, the present technology provides flexible battery and structural configurations that can accommodate the hinge sections.

For example, FIG. 3 illustrates a configuration where battery control board 315 is maintained within a rigid section of the enclosure 302, while batteries 310 extend across the rigid sections through the hinge sections. Batteries 310 may include a pouch 312 and a cell stack 313, which may be coupled with battery control board 315 with electrode tabs 314. Cell stack 313 may include any of the aspects of battery cell 200 described above, and the batteries may include any layers, components, or aspects of battery cell 200. As will be described below, the batteries included in electronic device 300 may include separated cell sections to limit active material within the hinge regions of the enclosure 302. Conventional battery cells may have limited flexibility because bending of the cells may cause delamination of cell active material. The present technology may produce multiple battery sections that may be electrically connected across the device sections of the electronic device.

As illustrated, batteries 310 may include a first battery section 316 housed within the first device section 304, which may be a rigid section as previously described. A second battery section 318 may be housed in the second device section 306, and a third battery section 320 may be housed in the third device section 308. In embodiments encompassed by the present technology the batteries may include more or less battery sections compared to device sections. Additionally, the battery sections may be characterized by similar or different dimensions to accommodate different device sections. For example, as illustrated, second device section 306 may be larger than third device section 308. Accordingly, second battery section 316 may be larger than third battery section 320. Any number of different sizes may be accommodated in flexible configurations according to embodiments of the present technology. By maintaining the battery cell materials within the rigid device sections, the cell material may be maintained rigid as well while the hinge section is articulated. Consequently, each device section and incorporated battery section may be maintained rigid during bending or other flexing operations of the sections about hinge sections of the enclosure.

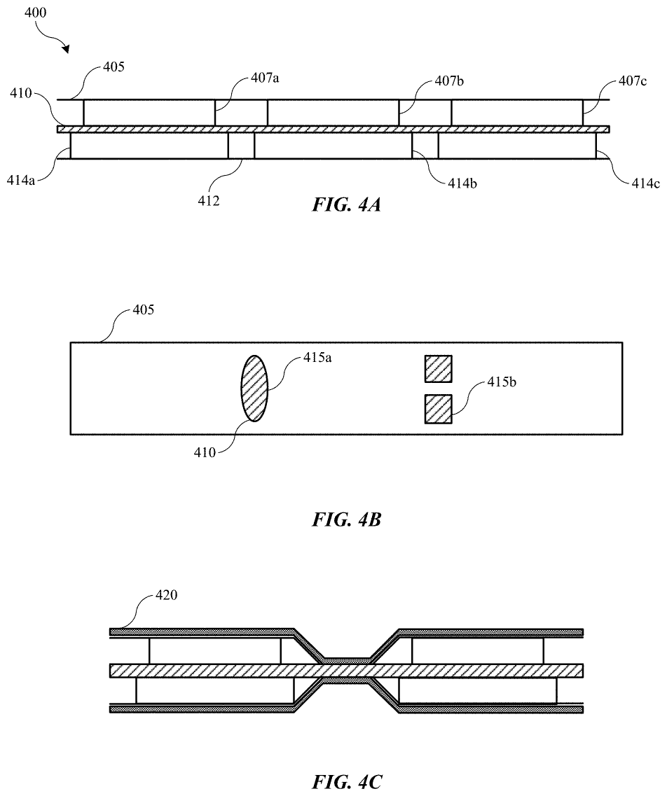

FIG. 4A shows a schematic cross-sectional view of a battery cell 400, and may illustrate the battery sections formed for batteries according to some embodiments of the present technology. Battery cell 400 may be contained within a pouch or enclosure, such as pouch 312 described above. The battery cell may include any of the components described above for battery cell 200, including multiple stacks of components. As noted previously, the present technology may limit or prevent location of battery cell active material along the hinge sections of the electronic device to limit or prevent delamination or peeling during bending operations. However, the battery sections may be maintained along other common components. For example, a separator and current collectors may extend fully along each battery section within the battery.

As illustrated, a first current collector 405 may extend the length of the battery and may have a first section 407a of a first electrode active material seated along the current collector in discrete sections, which may be sized for the device sections of the electronic device. A second section 407b of the first electrode active material may be spaced apart from first section 407a, and may be positioned to correspond with a second device section. Similarly, a third section 407c of the first electrode active material may be spaced apart from second section 407b, and may be positioned to correspond with a third device section. This may be repeated for any number of device sections, and may collectively operate as one electrode, such as a cathode or anode, of a formed battery. A separator 410 may extend fully along the length of the battery similar to the current collector, and may contact each section of electrode active material.

The battery may have an additional or second current collector 412 that may extend the length of the battery similar to the first current collector 405. The second current collector 412 may include sections of a second electrode active material, which may be the other of the cathode or anode active material from sections 407. For example, a first section 414a, a second section 414b, and a third section 414c of the second electrode active material may be seated along the current collector in corresponding sections relative to the first electrode active material to allow the regions to produce ionic transmission between the active materials. Hence, the individual sections of active material may produce the separate battery sections of each battery. In this configuration, the active materials may all be maintained within the rigid device sections of the electronic device, while the current collectors and the separator may extend through each rigid section and each hinge section. Current collector foils are typically on the order of a few dozen micrometers in thickness, or less, and may be readily bent or folded with little concern of mechanical impact. Similarly, the separator may be a polymeric material that may readily bend without damage. Accordingly, these components may extend fully through the battery connecting the battery sections through the hinge sections of the electronic device. This may allow the electronic device to be folded or bent along the hinge sections without impacting the battery cell, such as by delaminating or fracturing the electrode active materials.

The battery cell materials may be further adjusted or modified to accommodate operation in folded scenarios in some embodiments. FIG. 4B shows a schematic top view of a battery cell 400 according to some embodiments of the present technology. The figure may illustrate some exemplary configurations that may modify the current collectors in one or more ways to accommodate sealing operations explained below. The figure may illustrate a view along current collector 405, although current collector 412 may be similarly modified. For example, in some embodiments one or more apertures 415 may be defined through the current collector at a location corresponding to the hinge section of the electronic device. As will be explained below, in some embodiments the apertures may facilitate one or more sealing operations, and may expose separator 410 as illustrated. The apertures may be formed in any way, and may include a single aperture 415a at each hinge section, or multiple apertures 415b, any of which may be characterized by any different geometry or shape.

FIG. 4C shows a schematic partial cross-sectional view of battery cell 400 according to some embodiments of the present technology, such as when included within a battery pouch, such as pouch 312 discussed above. The pouch may provide an environmental seal preventing electrolyte leakage from the battery formed. For example, during fabrication, battery cell 400 may be seated within pouch 420, which may extend continuously about each battery section to fully encompass the battery, although electrode tabs may extend through the seals to afford coupling with the battery control board. Electrolyte may then be delivered into the pouch to be absorbed within each active material section and the separator. The pouch 420 may then be sealed to produce the battery. In some embodiments, the pouch 420 may additionally be sealed along each specific gap between the active material sections, which may correspond to the hinge sections of the electronic device.

When the electronic device is in a folded position for an extended period of time, electrolyte may pool in certain regions, and/or create dry spots within the cell sections. By at least partially sealing each cell section from adjacent cell sections, pooling may be reduced or eliminated. The electrolyte may still fluidly access each battery section, such as by the separator extending along the cell. Pouch 420 may be a polymeric material, and as separator 410 may also be a polymeric material, the pouch 420 may be sealed through the apertures in each current collector with the separator on each side of the separator as shown. The pouch and separator may essentially be heat sealed or bonded together to produce the seals between each cell section. This may facilitate the reduced thickness at each hinge section, which may accommodate bending of the components. This may also facilitate bending of the battery along the hinge sections, where the polymeric pouch and separator may further protect the current collectors through the hinge sections.

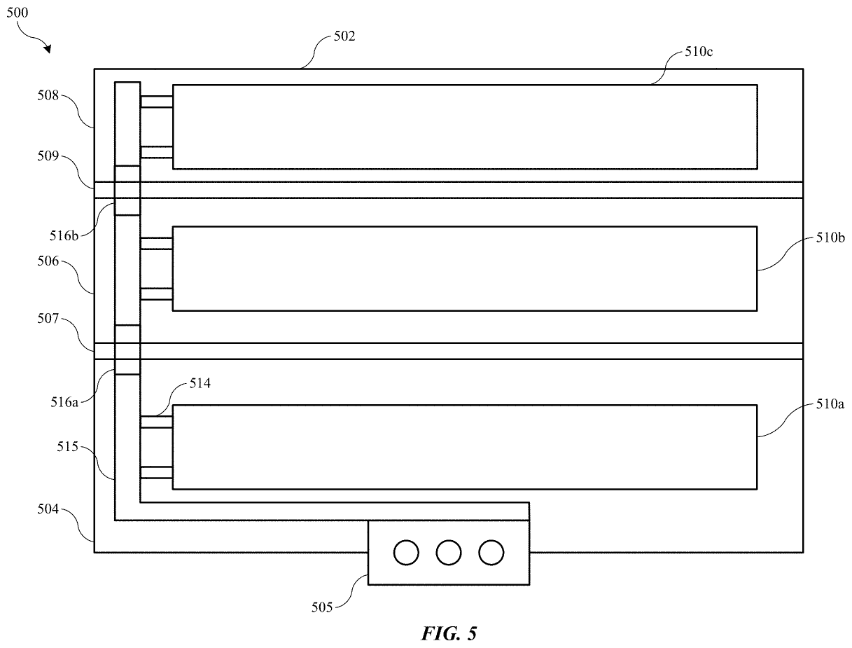

FIG. 5 shows a schematic view of components of an electronic device 500 according to some embodiments of the present technology. Electronic device 500 may have any of the features, aspects, or components of any of the other devices or batteries discussed previously, including the battery cell sections of electronic device 300, and may illustrate an additional configuration where the battery control board may extend across the hinge sections of the device. Similar to electronic device 300, electronic device 500 may include an enclosure 502 that may be coupled or connected with an electronic device, such as electronic device 100. Again, electronic device 500 may include a portion of an electronic device, such as a case, keyboard, dock, or other component that may be connected with electronic device 100, such as with connector 505. Electronic connector 505 may be located anywhere on the device 500, such as on a first device section 504. Although illustrated as a contact connector, electronic connector 505 may be any different type of connector including any electronic connector as previously described.

Electronic device 500 may have any number of device sections as previously discussed, and as illustrated may include a first device section 504 characterized by a first thickness, a second device section 506 characterized by a second thickness, and a third device section 508 characterized by a third thickness. The device sections may all be rigid sections as previously described, and may be characterized by a similar or different thickness to one another. Each device section may be coupled with an adjacent device section by a hinge section, such as hinge section 507 and hinge section 509. The hinge sections may allow device sections to be bendably coupled with an adjacent device section, which may allow the electronic device to be flexed into a number of forms or positions. The hinge sections may be characterized by a thickness that is less than the thickness of any or all of the device sections, which may facilitate bending along the hinges.

While electronic device 300 may include batteries that extend across each hinge section, electronic device 500 may include a battery system having batteries 510 that extend substantially parallel to the hinge sections, and may be contained, including fully contained within the individual device sections. For example, a first battery cell 510a may be housed within the first device section 504, and may extend within that section substantially parallel to the hinge section. By substantially parallel may be meant a less than perfectly parallel orientation, although the battery cell may not extend into or across the hinge section in embodiments. Similarly, a second battery cell 510b may be housed within the second device section and may extend within that section substantially parallel to the hinge sections. Additionally, third battery cell 510c may be housed within the third device section and may extend within that section substantially parallel to the hinge sections. In some embodiments, each battery cell 510 may be a fully contained battery coupled separately with a battery control board 515 with electrode tabs 514.

Battery control board 515 may electrically connect with each battery cell 510, and may electrically couple the battery cells with the electronic connector 505 as illustrated. In some embodiments, battery control board 515 may extend across each hinge section as illustrated. The battery control board may include multiple sections as illustrated, which may include sections to accommodate the hinge sections of the electronic device. For example, the control board may include a first control board section housed within the first device section 504 and electrically coupled with the first battery cell 510a, a second control board section housed within the second device section 506 and electrically coupled with the second battery cell 510b, and a third control board section housed within the third device section 508 and electrically coupled with the third battery cell 510c. These control board sections may be electrically coupled together with flex sections 516 that may extend through the hinge sections of the electronic device 500. For example, a first flex section 516a may electrically couple the first control board section with the second control board section, and a second flex section 516b may electrically couple the second control board section with the third control board section. Any number of additional flex sections may be included to extend through additional hinge sections as well.

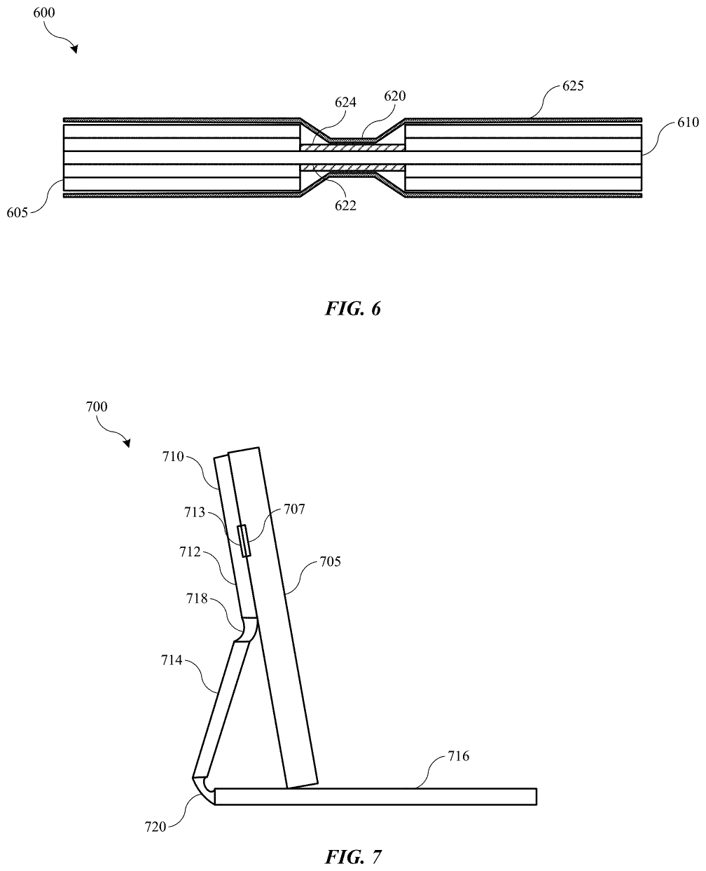

FIG. 6 shows a schematic cross-sectional view of a battery control board 600 according to some embodiments of the present technology, and may illustrate additional details of battery control board 515 described above. Battery control board 600 may include a first control board section 605 and a second control board section 610, which may include a printed circuit board of any number of varieties, or other control board arrangement. The control board sections may include a multilayer configuration including one or more reinforced board sections, which may be or include a glass epoxy laminate, or any other material. One or more copper or other conductive layers may also extend as layers of the board. The layers may produce a composite that can receive power from the connected battery cells, provide or modulate power to the cells, as well as monitor the cells. The composite sections may not be able to accommodate the hinge sections of the enclosure due to rigidity, and thus in some embodiments the control board sections may be coupled together with flex sections, such as flex section 620.

The flex section may be or include a conductive film 622 extending from the first control board section to the second control board section, as well as any other control board sections. The conductive film may extend continuously, or be joined, welded, bonded or otherwise coupled between the control board sections. Similar to the current collectors of the battery cells described above, the film may be of a similar size, and may readily accommodate bending or flexing during articulation of the hinge section of the electronic device. Additional aspects may also be included in the flex section 620. For example, the flex section 620 may include a polymeric or other insulating material 624 encapsulating the conductive film on one or both sides as illustrated. The encapsulant may electrically insulate the conductive film, and may also accommodate bending through the flex section.

An enclosure 625, which may be a housing material of the electronic device, such as enclosure 502, may be characterized by reduced thickness through the hinge sections of the device, and the housing material may extend fully about the electronic device including each device section and each hinge section. The enclosure 625 may be an environmental protection and may be an insulative material, such as including a polymeric or rubberized material. In some embodiments, such as illustrated, the housing material may be sealingly coupled with the polymeric material 624 encapsulating the conductive film through the flex sections. This may control, limit, or prevent movement of the control board within the electronic device to ensure the control board sections are maintained away from the hinge sections.

The electronic devices as previously described may be utilized in electronic systems where they may be coupled with other electronic devices to provide an additional power source for the electronic device as previously explained. FIG. 7 shows a schematic view of an electronic system 700 according to some embodiments of the present technology. The system may include any of the devices as previously described, and may include any aspect, component, or characteristics of any device discussed above. For example, the electronic system may include a first electronic device 705, which may be similar to electronic device 100 and may include any aspect or component of device 100. For example, first electronic device 705 may include a display on a first surface of the first electronic device as described previously, and may include a first electronic connector 707, such as on a surface opposite the display surface, or any side surface. The first electronic device 705 may also include a first battery housed within the electronic device, and which may power operation of the device.

Electronic system 700 may also include a second electronic device 710, which may be or include any aspect of electronic device 300 and/or electronic device 500 described above. The second electronic device 710 may include one or more device sections including a first device section 712 having a second electronic connector 713. Second electronic connector 713 may be a contact connector or any other type of connector that engages with first electronic connector 707, and which may allow data and/or power to transfer from either electronic device to the other. The first device section 712 may be characterized by a first thickness. The electronic device 710 may include a second device section 714 characterized by a second thickness, which may be the same as the first thickness. The second electronic device may include any number of additional device sections or components, such as a third device section 716, which may be configured to extend across the first or display surface of the first electronic device, and may also at least partially operated as a stand for the first electronic device as illustrated.

Each device section of the second electronic device may be coupled together with a hinge section as illustrated, and as previously described. For example, a first hinge section 718 may be coupled along a length of the first device section 712 and the second device section 714, allowing the second device section to be bendably coupled with the first device section. The second electronic device may also have a second hinge section 720 extending along a length of the second device section and the third device section allowing the third device section to be bendably coupled with the second device section. As illustrated, the hinge sections may be characterized by a thickness less than a thickness of the device sections in some embodiments to accommodate flexing and bending of the device.

The second electronic device may also have one or more second batteries included within the second electronic device, which may be operated to provide additional power to the first electronic device. This may facilitate further reductions in scale of the first electronic device that may reduce the size and capacity of the first battery, while not reducing the capacity of the system. In some embodiments, by incorporating batteries within the second electronic device as previously described, the capacity of the system may be increased over conventional electronic devices. Either the battery control board or the battery cells within the second electronic device may include features as previously described from either or both of electronic device 300 or electronic device 500 to accommodate the hinge sections of the device. This may provide a flexible electronic device incorporating one or more batteries that may further power the first electronic device 705.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included. Where multiple values are provided in a list, any range encompassing or based on any of those values is similarly specifically disclosed.

As used herein and in the appended claims, the singular forms “a”, “an”, and “the” include plural references unless the context clearly dictates otherwise. Thus, for example, reference to “a material” includes a plurality of such materials, and reference to “the layer” includes reference to one or more layers and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed is:

1. An electronic device comprising:
a first device section having an electronic connector, the first device section characterized by a first thickness;
a second device section characterized by a second thickness;
a hinge section extending along a length of the first device section and a length of the second device section, wherein the second device section is bendably coupled with the first device section about the hinge section, and wherein the hinge section is characterized by a third thickness less than the first thickness and the second thickness; and
a battery comprising:
a first battery section housed in the first device section, the first battery section comprises a current collector, a first section of an electrode active material, and a separator, and
a second battery section housed in the second device section, the second battery section comprising the current collector, a second section of the electrode active material, and the separator, wherein the current collector and the separator extend through the hinge section of the electronic device.

2. The electronic device of claim 1, further comprising a battery control board electrically coupling the battery with the electronic connector.

3. The electronic device of claim 1, wherein the electronic connector comprises a contact connector or a magnetically actuated connector.

4. The electronic device of claim 1, wherein the first device section and the second device section are configured to maintain rigidity while the hinge section is articulated.

5. The electronic device of claim 1, wherein the current collector defines an aperture through the current collector at the hinge section.

6. The electronic device of claim 5, wherein the battery comprises a pouch extending continuously about the first battery section and the second battery section.

7. The electronic device of claim 6, wherein the pouch comprises a polymeric material, and wherein the pouch is sealingly coupled with the separator through the aperture defined through the current collector.

8. The electronic device of claim 7, wherein the battery further comprises an electrolyte, and wherein both the first battery section and the second battery section are fluidly accessible to the electrolyte.

9. An electronic device comprising:
a first device section having an electronic connector, the first device section characterized by a first thickness;
a second device section characterized by a second thickness;
a hinge section extending between the first device section and the second device section, wherein the second device section is bendably coupled with the first device section about the hinge section, and wherein the hinge section is characterized by a third thickness less than the first thickness and the second thickness;
a battery system comprising:
a first battery cell housed within the first device section and extending substantially parallel to the hinge section of the electronic device, and
a second battery cell housed within the second device section and extending substantially parallel to the hinge section of the electronic device; and
a battery control board electrically coupling the first battery cell and the second battery cell with the electronic connector.

10. The electronic device of claim 9, wherein the battery control board comprises:
a first control board section housed in the first device section, wherein the first control board section is electrically coupled with the first battery cell; and
a second control board section housed in the second device section, wherein the second control board section is electrically coupled with the second battery cell.

11. The electronic device of claim 10, wherein the battery control board further comprises a flex section coupling the first control board section with the second control board section, and wherein the flex section extends through the hinge section of the electronic device.

12. The electronic device of claim 11, wherein the flex section comprises a conductive film extending from the first control board section to the second control board section, and wherein the conductive film is encapsulated in a polymeric material between the first control board section and the second control board section.

13. The electronic device of claim 12, further comprising:
a housing extending about the first device section, the second device section, and the hinge section of the electronic device.

14. The electronic device of claim 13, wherein the housing comprises a polymeric material, and wherein the housing is sealingly coupled with the polymeric material encapsulating the conductive film.

15. The electronic device of claim 9, wherein the electronic connector comprises a contact connector or a magnetically actuated connector.

16. An electronic system comprising:
a first electronic device comprising a display on a first surface of the first electronic device, wherein the first electronic device comprises a first electronic connector, and wherein the first electronic device comprises a first battery housed within the first electronic device; and
a second electronic device comprising:
a first device section having a second electronic connector, the first device section characterized by a first thickness;
a second device section characterized by a second thickness;
a hinge section extending along a length of the first device section and a length of the second device section, wherein the second device section is bendably coupled with the first device section about the hinge section, and
a second battery comprising:
a first battery section housed in the first device section, the first battery section comprises a current collector, a first section of an electrode active material, and a separator, and
a second battery section housed in the second device section, the second battery section comprising the current collector, a second section of the electrode active material, and the separator, wherein the current collector and the separator extend through the hinge section of the second electronic device.

17. The electronic system of claim 16, wherein the second electronic connector is configured to engage with the first electronic connector, and wherein the second electronic connector is further configured to provide power to the first electronic device from the second battery.

18. The electronic system of claim 16, wherein the current collector defines an aperture through the current collector at the hinge section.

19. The electronic system of claim 18, wherein the second battery comprises a pouch extending continuously about the first battery section and the second battery section.

20. The electronic system of claim 19, wherein the pouch comprises a polymeric material, and wherein the pouch is sealingly coupled with the separator through the aperture defined through the current collector.
